(19) United States
(12) Patent Application Publication
(10) Pub. No.: US 2016/0084155 A1
(43) Pub. Date: Mar. 24, 2016

(54) TURBOCHARGER SYSTEM

(71) Applicant: GM GLOBAL TECHNOLOGY OPERATIONS LLC, Detroit, MI (US)

(72) Inventors: Domenico RAMPONE, Asti (IT); Vincenzo PETRONZI, Turin (IT); Philip Silvio Junior TRASSATTI, Roseto degli Abruzzi (IT)

(73) Assignee: GM GLOBAL TECHNOLOGY OPERATIONS LLC, Detroit, MI (US)

(21) Appl. No.: 14/858,062

(22) Filed: Sep. 18, 2015

(30) Foreign Application Priority Data
Sep. 20, 2014 (DE) 202014007678.2

(51) Int. Cl. F02B 37/24; F02M 25/07

(52) U.S. Cl. CPC F02B 37/24; F02M 25/0706

(57) ABSTRACT

A turbocharger system for an internal combustion engine is disclosed which includes a variable-geometry-turbine having movable vanes, an electric actuator coupled to rotate the movable vanes. An electronic control unit is configured to operate the electric actuator for rotating the movable vanes until they reach a mechanical stop corresponding to a fully-open position. A position sensor learns the position value of the movable vanes, once they have reached the mechanical stop.

### CROSS-REFERENCE TO RELATED APPLICATION

This application claims priority to German Patent Application No. 2020140076782, filed Sep. 20, 2014, which is incorporated herein by reference in its entirety.

### TECHNICAL FIELD

The present disclosure pertains to a turbocharger system for an internal combustion engine, typically an internal combustion engine of a motor vehicle.

### BACKGROUND

It is known that an internal combustion engine may include a turbocharger provided for increasing the engine efficiency and power by forcing air into the engine combustion chambers. The turbocharger conventionally includes a turbine, which is located in an engine exhaust pipe, and a compressor, which is rotationally coupled with the turbine and is located in an engine intake pipe. The turbine is rotated by the exhaust gases coming from engine combustion chambers and drives the compressor, which increases the pressure of the air directed into the combustion chambers. In some embodiments, the turbine may be a variable geometry turbine (VGI), also known as variable nozzle turbine (VNT).

The VGT basically includes a turbine housing, a turbine wheel accommodated in the turbine housing, and a plurality of movable aerodynamically-shaped vanes disposed around the turbine wheel, inside the turbine housing, to direct the exhaust gas coming from the turbine inlet towards the blades of the turbine wheel. These movable vanes may be mechanically coupled to an annular rack, which can rotate inside the turbine housing and which is coupled to a rotating shaft of an electric motor (i.e. VGT actuator) by means of a transmission leverage. Adjusting the angular position of the annular rack, the VGT actuator causes the vanes to rotate in unison to vary the gas swirl angle and the cross sectional area of the turbine inlet.

The VGT actuator is operated by an electronic control unit (ECU), which is configured to adjust the orientation of the turbine vanes on the basis of a boost request, in order to optimize the performance of the turbocharger. The boost request may be determined by the ECU on the basis of a number of engine operating parameters, including for example the engine speed. This is done because a too wide gas swirl angle and cross sectional area will fail to create enough air boost at low engine speeds, whereas a too small gas swirl angle and cross sectional area will choke the engine at high speeds, leading to high exhaust gas pressures, high pumping losses, and ultimately lower power output.

Potentially, the VGT vanes can rotate between two mechanical-end-stop positions, including a fully-open position and a fully-close position. In the fully-open position, which is generally determined by a mechanical pin or a similar stationary mechanical stop, the vanes are at their maximum inclination towards the central axis of the turbine wheel, thereby maximizing the cross sectional area and thus the mass flow rate of the incoming exhaust gases. In the fully-close position, which is generally determined by a mutual contact between the vanes, the vanes are almost tangentially oriented with respect to the central axis of the turbine wheel, thereby minimizing the cross sectional area and the exhaust gas mass flow rate.

During the normal engine operations, the ECU is configured so that these fully-open and the fully-closed positions are never reached, Instead, the VGT vanes are bound to rotate between a minimum flow (Min-Flow) position that is proximal to the fully-closed position and a maximum flow (Max-Flow) position that is proximal to the fully-open position. More particularly, the Min-flow position, which is the position of the VGT vanes that corresponds to a maximum (100%) of the boost request, is generally determined by the supplier of the VGT system. Starting from this Min-Flow position, the VGT vanes are then allowed to rotate only for a predetermined maximum angular range, whose opposite end defines the Max-Flow position as consequence.

In order to prevent the VGT vanes of any VGTs from reaching the mechanical stop corresponding to the fully-open position, the above-mentioned maximum angular range is set by the VGT supplier to be quite small, for example of about 69° (degrees) of rotation from the Min-Flow position. However, this strategy has the drawback that, for many VGTs, the Max-Flow position may be too far removed from the actual fully-open position. This fact can lead to turbocharger over-speed and/or uncontrolled boost when trying to achieve maximum exhaust flow discharge, particularly at high engine speed and/or under extreme operating conditions (e.g. hot condition at sea level).

### SUMMARY

In accordance with the present disclosure a solution is provided that addresses the above mentioned drawback in a simple, rational and rather inexpensive solution. More particularly, an embodiment of the present disclosure provides a turbocharger system for an internal combustion engine, including a variable-geometry-turbine (VGT) having movable vanes, an electric actuator (e.g. motor) coupled to rotate the movable vanes, and an electronic control unit configured to operate the electric actuator to rotate the movable vanes until they reach a mechanical stop corresponding to a fully-open position. A position sensor learns the position value of the movable vanes, once they have reached the mechanical stop. Thus, it is possible to determine, for each individual turbocharger system, the position of the movable vanes that actually corresponds to the VGT fully-open position.

According to an aspect of the present disclosure, the electronic control unit may be configured to use the learned position value to calculate a threshold position value corresponding to a max-flow position, beyond which the movable vanes are not allowed to rotate during the normal operations of the turbocharger system. This aspect has the effect that the max-flow position may be customized for each individual turbocharger system, allowing each individual turbocharger system to move the vanes over an optimal angular range and thus preventing uncontrolled boost and/or turbocharger over-speed events.

According to another aspect of the present disclosure, the electronic control unit may be configured to use the threshold value to limit a predetermined characteristic curve that correlates the values of an electrical signal generated by the position sensor to correspondent values of the vanes position. Thus, the characteristic curve, which may be the same for all the VGTs of the same family and which will be used during the normal engine operation for monitoring the position of the VGT vanes, is not modified by the proposed strategy but simply limited (i.e. cut) to the max-flow position determined for the specific turbocharger system.

According to another aspect of the present disclosure, the electronic control unit may be configured to calculate the threshold position value as the difference between the learned position value and a predetermined angular offset. Thus, a reliable max-flow position with a very simple solution.

Another aspect of the present disclosure provides that, while performing the above-proposed strategy, the electronic control unit may be configured to supply the electric actuator with a train of electrical tension pulses to rotate the movable vanes towards the mechanical stop. The position sensor is used to measure the position of the movable vanes during the rotation. An error is calculated between the measured value of the movable vanes position and a set-point value thereof. A controller is used to adjust a duty-cycle value of the electrical tension pulses on the basis of the calculated error. In other words, the electronic control unit to operate the electric actuator with a closed loop strategy based on the actual position of the VGT movable vanes.

According to another aspect of the present disclosure, the electronic control unit may be configured to vary the above-mentioned set-point value of the vane's position from a first target value to a second target value. The first target value represents the position of a vane that precedes the fully-open position, and the second target value represents the position of a vane that is beyond the fully-open position (both the first and the second target positions being referred to the rotation direction of the movable vanes towards the fully-open position). As a result, it is possible to reduce and control the speed at which the electric actuator rotates the VGT movable vanes towards the mechanical stop.

An aspect of the present disclosure provides hat the electronic control unit may be configured to vary the set-point position linearly over the time. In this way, it is possible to achieve a soft approaching of the movable vane to the mechanical stop that defines the fully-open position, which is slow enough to prevent the movable vanes from being damaged.

According to another aspect of the present disclosure the electronic control unit may be configured to use the absolute value of the duty-cycle of the electrical tension pulses to identify when the movable vanes have reached the mechanical stop. This aspect provides a reliable solution to identify when the movable vanes have reached the mechanical stop.

According to another aspect of the present disclosure, the electronic control unit may configured to identify that the movable vanes have reached the mechanical stop, when the duty-cycle absolute value of the electrical tension pulses exceeds a predetermined threshold value thereof. This aspect of the present disclosure provides a reliable solution to identify the reaching of the mechanical stop. Indeed, once the VGT movable vanes stop against the mechanical stop, the duty-cycle of the electrical tension pulses will start to increase fast, because the controller becomes able to compensate the error between the measured position value and the set-point position value. As a consequence, if the duty-cycle exceeds a predetermined threshold value for more than a predetermined time, it means that the movable vanes have reached the mechanical stop. In order to not be misled by possible spike in the duty-cycle due for example to noises or other transitory phenomena, the identification may be completed if the duty-cycle absolute value of the electrical tension pulses exceeds the threshold value for more than a predetermined time (delay).

According to still another aspect of the present disclosure, the electronic control unit may be configured to supply the electric actuator with a train of electrical tension pulses having a predetermined target value of the duty-cycle, once the movable vane have reached the mechanical stop, this duty-cycle target value of the electrical tension pulses being smaller than the threshold value thereof. This solution allows to keep the movable vanes firmly against the mechanical stop while protecting the electric actuator from being operated with a too high duty-cycle, which otherwise could cause an overheat of the electric actuator and/or the movable vanes to push too hard against the mechanical stop.

According to another aspect of the present disclosure, the controller may be a proportional-integrative-derivative (PID) controller. A controller of this type is particularly effective for the implementation of the proposed strategy.

According to another aspect of the present disclosure, once the mechanical stop has been reached, the electronic control unit may be configured to learn the position value of the movable vanes. The position sensor measures the position of the movable vanes several times. An average of the measured position values is calculated and used to set the calculated average as the position value of the movable vanes corresponding to the fully-open position. This aspect of the present disclosure provides an effective solution to learn a robust and reliable fully-open position of the VGT movable vanes.

Another embodiment of the present disclosure provides an automotive system including an internal combustion engine and the turbocharger system.

Still another embodiment of the present disclosure provides a method of operating an internal combustion engine having a turbocharger system including a variable-geometry-turbine (VGT) with movable vanes, and an electric actuator (e.g. motor) coupled to rotate the movable vanes. The electric actuator is operated to rotate the movable vanes until they reach a mechanical stop corresponding to a fully-open position. A position sensor learns the position value of the movable vanes, once they have reached the mechanical stop. As a result, it is possible to determine, for each individual turbocharger system, the position of the movable vanes that actually corresponds to the VGT fully-open position.

According to an aspect of the present disclosure, the method may use the learned position value to calculate a threshold position value corresponding to a max-flow position, beyond which the movable vanes are not allowed to rotate during the normal operations of the turbocharger system. This aspect has the effect that the max-flow position may be customized for each individual turbocharger system, allowing each individual turbocharger system to move the vanes over an optimal angular range and thus preventing uncontrolled boost and/or turbocharger over-speed events.

According to another aspect of the present disclosure, the method may use the threshold value to limit a predetermined characteristic curve that correlates the values of an electrical signal generated by the position sensor to correspondent values of the vanes position. Thus, the characteristic curve is not modified by the proposed strategy but simply limited (i.e. cut) to the max-flow position determined for the specific turbocharger system.

According to another aspect of the present disclosure, the method may calculate the threshold position value as the difference between the learned position value and a predetermined angular offset. This aspect of the present disclosure provides a reliable max-flow position with a very simple solution.

Another aspect of the present disclosure provides that, while performing the above-proposed strategy, the electric actuator may be supplied with a train of electrical tension pulses to rotate the movable vanes towards the mechanical stop. The position sensor to measure the position of the movable vanes during the rotation. An error is calculated between the measured value of the movable vanes position and a set-point value thereof. A controller adjusts a duty-cycle value of the electrical tension pulses on the basis of the calculated error. In other words, this aspect of the present disclosure provides for operating the electric actuator with a closed loop strategy based on the actual position of the VGT movable vanes.

According to another aspect of the present disclosure, the method may vary the above-mentioned set-point value of the vane's position from a first target value to a second target value. The first target value represents a vane's position that precedes the fully-open position and the second target value represents a vane's position that is beyond the fully-open position (both the first and the second target positions being referred to the rotation direction of the movable vanes towards the fully-open position). This solution makes it possible to reduce and control the speed at which the electric actuator rotates the VGT movable vanes towards the mechanical stop.

An aspect of the present disclosure provides that the set-point value may be varied linearly over the time. In this way, it is possible to achieve a soft approaching of the movable vane to the mechanical stop that defines the fully-open position, which is slow enough to prevent the movable vanes from being damaged.

According to another aspect of the present disclosure, the method may use the absolute value of the duty-cycle of the electrical tension pulses to identify when the movable vanes have reached the mechanical stop. This aspect provides a reliable solution to identify when the movable vanes have reached the mechanical stop.

According to another aspect of the present disclosure, the method may identify that the movable vanes have reached the mechanical stop, when the duty-cycle absolute value of the electrical tension pulses exceeds a predetermined threshold value thereof. This aspect of the present disclosure provides a reliable solution to identify the reaching of the mechanical stop. Indeed, once the VGT movable vanes stop against the mechanical stop, the duty-cycle of the electrical tension pulses will start to increase fast, because the controller becomes able to compensate the error between the measured position value and the set-point position value. As a consequence, if the duty-cycle exceeds a predetermined threshold value for more than a predetermined time, it means that the movable vanes have reached the mechanical stop. In order to not be misled by possible spike in the duty-cycle due for example to noises or other transitory phenomena, the identification may be completed if the duty-cycle absolute value of the electrical tension pulses exceeds the threshold value for more than a predetermined time a delay).

According to still another aspect of the present disclosure, the method may supply the electric actuator with a train of electrical tension pulses having a predetermined target value of the duty-cycle, once the movable vane have reached the mechanical stop, this duty-cycle target value of the electrical tension pulses being smaller than the threshold value thereof. This solution allows to keep the movable vanes firmly against the mechanical stop while protecting the electric actuator from being operated with a too high duty-cycle, which otherwise could overheat the electric actuator and/or the movable vanes to push too hard against the mechanical stop.

According to another aspect of the present disclosure, the controller may be a proportional-integrative-derivative (PID) controller. This kind of controller is particularly effective for the implementation of the proposed strategy.

According to another aspect of the present disclosure, once the mechanical stop has been reached, the method may learn the position value of the movable vanes. In particular, the position sensor measures the position of the movable vanes several times. An average of the measured position values is calculated and used to set the position value of the movable vanes corresponding to the fully-open position. This aspect of the present disclosure provides an effective solution to learn a robust and reliable fully-open position of VGT movable vanes.

The method of the present disclosure may be enabled in a computer program including a program-code for carrying out all the method described above, and in the form of a computer program product including the computer program. The method may also be embodied as an electromagnetic signal, said signal being modulated to carry a sequence of data bits which represent a computer program to carry out all steps of the method.

Another embodiment of the present disclosure provides a turbocharger system including a variable-geometry-turbine (VGT) having movable vanes, an electric actuator (e.g. motor) coupled to rotate the movable vanes. The electric actuator is operable to rotate the movable vanes until they reach a mechanical stop corresponding to a fully-open position. A position sensor learns the position value of the movable vanes, once they have reached the mechanical stop. Thus, it is possible to determine, for each individual turbocharger system, the position of the movable vanes that actually corresponds to the VGT fully-open position.

According to an aspect of the present disclosure, the turbocharger system use the learned position value to calculate a threshold position value corresponding to a max-flow position, beyond which the movable vanes are not allowed to rotate during the normal operations of the turbocharger system. This aspect has the effect that the max-flow position may be customized for each individual turbocharger system, allowing each individual turbocharger system to move the vanes over an optimal angular range and thus preventing uncontrolled boost and/or turbocharger over-speed events.

According to another aspect of the present disclosure, the turbocharger system may use the threshold value to limit a predetermined characteristic curve that correlates the values of an electrical signal generated by the position sensor to correspondent values of the vanes position. As a result, the above-identified characteristic curve is not modified by the proposed strategy but simply limited (i.e. cut) to the max-flow position determined for the specific turbocharger system.

According to another aspect of the present disclosure, the turbocharger system may calculate the threshold position value as the difference between the learned position value and a predetermined angular offset. This aspect of the present disclosure provides a reliable max-flow position with a very simple solution.

Another aspect of the present disclosure the electric actuator is operable to with a train of electrical tension pulses to rotate the movable vanes towards the mechanical stop.

The position sensor measures the position of the movable vanes during the rotation. An error is calculated between the measured value of the movable vanes position and a set-point value thereof. A controller is used to adjust a duty-cycle value of the electrical tension pulses on the basis of the calculated error. In other words, this aspect of the present disclosure provides for operating the electric actuator with a closed loop strategy based on the actual position of the VGT movable vanes.

According to another aspect of the present disclosure, the turbocharger system may vary the above-mentioned set-point value of the position of the vane from a first target value to a second target value. The first target value represents a position of the vane that precedes the fully-open position, and the second target value represents a position of the vane that is beyond the fully-open position (both the first and the second target positions being referred to the rotation direction of the movable vanes towards the fully-open position). This solution makes it possible to reduce and control the speed at which the electric actuator rotates the VGI movable vanes towards the mechanical stop.

An aspect of the present disclosure provides for varying the set-point value linearly over the time. In this way, it is possible to achieve a soft approaching of the movable vane to the mechanical stop that defines the fully-open position, which is slow enough to prevent the movable vanes from being damaged.

According to another aspect of the present disclosure, the turbocharger system may use the absolute value of the duty-cycle of the electrical tension pulses to identify when the movable vanes have reached the mechanical stop. This aspect provides a reliable solution to identify when the movable vanes have reached the mechanical stop.

According to another aspect of the present disclosure, the turbocharger system may identify that the movable vanes have reached the mechanical stop, when the duty-cycle absolute value of the electrical tension pulses exceeds a predetermined threshold value thereof. This aspect of the present disclosure provides a reliable solution to identify the reaching of the mechanical stop. Indeed, once the VGI movable vanes stop against the mechanical stop, the duty-cycle of the electrical tension pulses will start to increase fast, because the controller becomes enable to compensate the error between the measured position value and the set-point position value. As a consequence, if the duty-cycle exceeds a predetermined threshold value for more than a predetermined time, it means that the movable vanes have reached the mechanical stop. In order to not be misled by possible spike in the duty-cycle due for example to noises or other transitory phenomena, the identification may be completed if the duty-cycle absolute value of the electrical tension pulses exceeds the threshold value for more than a predetermined time (i.e., a delay).

According to still another aspect of the present disclosure, the turbocharger system may supply the electric actuator with a train of electrical tension pulses having a predetermined target value of the duty-cycle, once the movable vane have reached the mechanical stop, this duty-cycle target value of the electrical tension pulses being smaller than the threshold value thereof. This solution allows to keep the movable vanes firmly against the mechanical stop while protecting the electric actuator from being operated with a too high duty-cycle, which otherwise could overheat the electric actuator and/or the movable vanes to push too hard against the mechanical stop.

According to another aspect of the present disclosure, the controller may be a proportional-integrative-derivative (PID) controller. This kind of controller is particularly effective for the implementation of the proposed strategy.

According to another aspect of the present disclosure, the position value of the movable vanes is learned using the position sensor to measure the position of the movable vanes several times, and calculating an average of the measured position values. The calculated average is used as the position value of the movable vanes corresponding to the fully-open position. This aspect of the present disclosure provides an effective solution to learn a robust and reliable fully-open position of the VGR movable vanes.

### BRIEF DESCRIPTION OF THE DRAWINGS

The present disclosure will hereinafter be described in conjunction with the following drawing figures, wherein like numerals denote like elements.

FIG. 1 schematically shows an automotive system according to an embodiment of the present disclosure;

FIG. 2 is a cross section of an internal combustion engine belonging to the automotive system taken at A-A of FIG. 1;

FIG. 3 is a prospective view of a transmission system that allows the VGT vanes to rotate;

FIG. 4 is a different prospective view of the transmission system showing also the VGT actuator;

FIG. 5 is a partial back-view of the transmission system of FIG. 3;

FIG. 6 is a flowchart representing a testing procedure according to an embodiment on the present disclosure;

FIG. 7 is a diagram wherein the X axis [% R] represents values of a boost request, the left Y axis [V] represents values of an electrical tension signal generated by a VGT position sensor expressed in bits, the right Y axis [Ω] represents values of an angular positions of the VGT vanes expressed in degrees, and curve F is a characteristic curve of the VGT position sensor that represents the relationship between the values of the generate signal, the values of the boost request and the values of the vanes' angular position; and

FIG. 8 is a diagram wherein the X axis [t] represents time values, the right Y axis [% DT] represents values of the duty-cycle of a train of electrical tension pulses applied to the VGT actuator, the left Y axis [Ω] represents values of an angular positions of the VGT vanes expressed in degrees, curve SPV represents the variation of a set-point value of the VGT vanes' position over the time, curve MV represents the variation of a measured value of the VGT vanes' position over the time, and curve DT represents the variation of the duty-cycle over the time.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

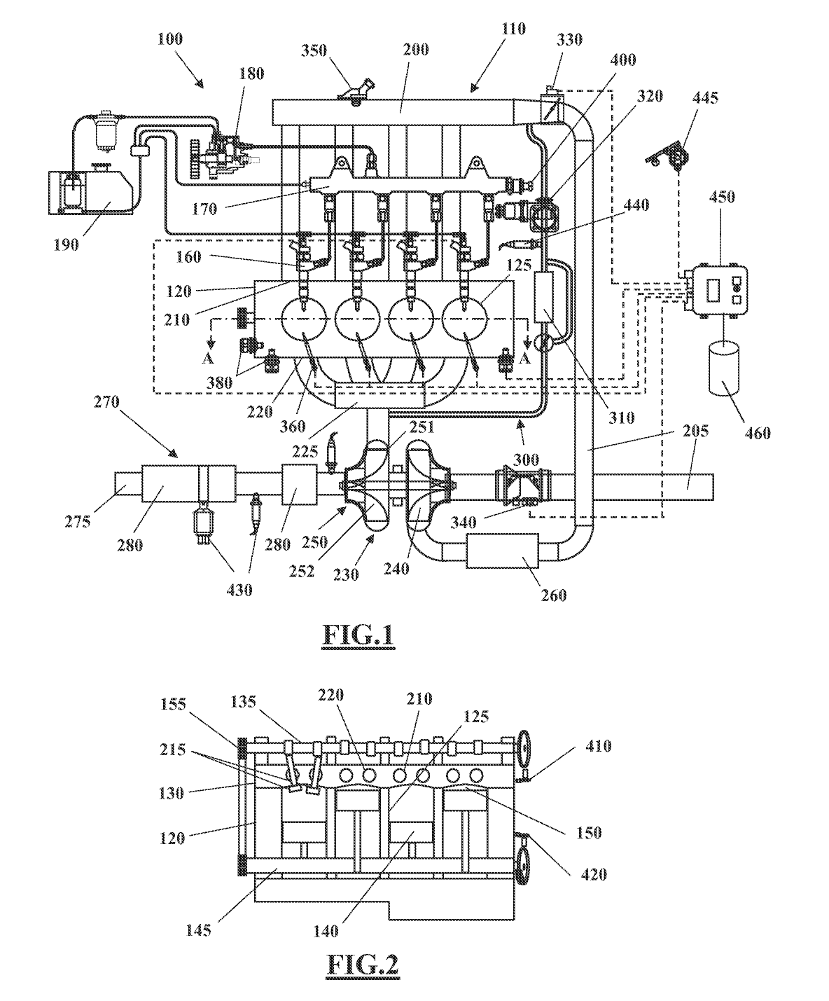

Some embodiments may include an automotive system 100, as shown in FIGS. 1 and 2, that includes an internal combustion engine (ICE) 110 having an engine block 120 defining at least one cylinder 125 having a piston 1140 coupled to rotate a crankshaft 145. A cylinder head 130 cooperates with the piston 140 to define a combustion chamber 150. A fuel and air mixture (not shown) is disposed in the combustion chamber 150 and ignited, resulting in hot expanding exhaust gasses causing reciprocal movement of the piston 140. The fuel is provided by at least one fuel injector 160 and the air through at least one intake port 210. The fuel is provided at high pressure to the fuel injector 160 from a fuel rail 170 in fluid communication with a high pressure fuel pump 180 that increase the pressure of the fuel received from a fuel source 190. Each of the cylinders 125 has at least two valves 215, actuated by a camshaft 135 rotating in time with the crankshaft 145. The valves 215 selectively allow air into the combustion chamber 150 from the port 210 and alternately allow exhaust gases to exit through a port 220. In some examples, a cam phaser 155 may selectively vary the timing between the camshaft 135 and the crankshaft 145.

The air may be distributed to the air intake port(s) 210 through an intake manifold 200. An air intake duct 205 may provide air from the ambient environment to the intake manifold 200. In other embodiments, a throttle body 330 may be provided to regulate the flow of air into the manifold 200. In still other embodiments, a forced air system such as a turbocharger 230, having a compressor 240 rotationally coupled to a turbine 250, may be provided, Rotation of the compressor 240 increases the pressure and temperature of the air in the duct 205 and manifold 200. An intercooler 265 disposed in the duct 205 may reduce the temperature of the air. The turbine 250 rotates by receiving exhaust gases from an exhaust manifold 225 that directs exhaust gases from the exhaust ports 220 and through a series of vanes prior to expansion through the turbine 250.

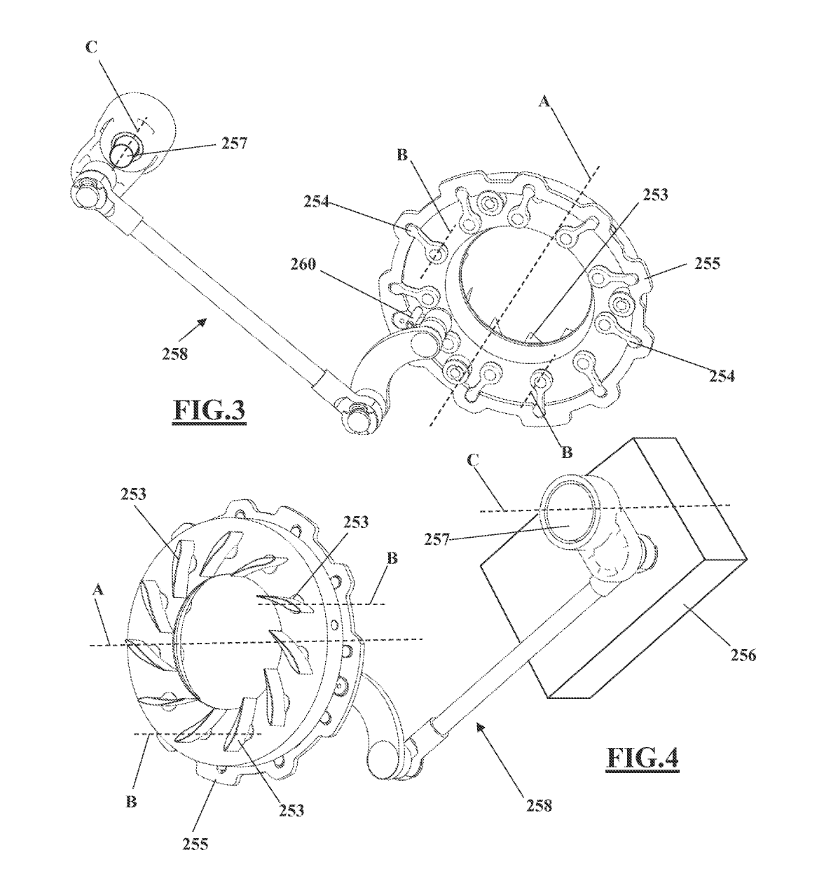

This example shows a variable geometry turbine (VGT), also known as variable nozzle turbine (VNT). The VGT 250 basically includes a turbine housing 251 and a turbine wheel 252 accommodated in the turbine housing 251. Inside the turbine housing 251, the VGT 250 further includes a plurality of movable aerodynamically-shaped vanes 253, as shown in FIGS. 3 and 4, Which are circumferentially disposed around the turbine wheel 252 (not shown in FIGS. 3 and 4) to direct the exhaust gas coming from the turbine inlet towards the blades of the turbine wheel 252.

Each vane 253 is coupled to the turbine housing 251 to be able to rotate about a respective axis B that is parallel to the rotation axis A of the turbine wheel 252. Through a connecting rod 254, each vane 253 is mechanically coupled to an annular rack 255 that can rotate inside the turbine housing 251 about the rotation axis A of the turbine wheel 252. In this way, any rotation of the annular rack 255 about the axis A causes all the vanes 253 to simultaneously rotate about the axes B, thereby changing their orientation. The rotation of the annular rack 255 is actuated by a VGT actuator 256 (FIG. 4), in this example an electric motor (e.g. a DC motor), having a rotating shaft 257 (FIG. 3). The rotating shaft 257 may be arranged to rotate about an axis C, parallel to the axis A, and may be coupled to the annular rack 255 through a leverage 258, so that a rotation of the shaft 257 about the axis C causes a rotation of the annular rack 255 about the axis A and thus a rotation of all the vanes 253 about their axes B. The speed ratio between the shaft 257 and the vanes 253 may be for example equal to 0.5, namely the rotation of the vanes 253 may be twice the rotation of the shaft 257.

The VGT actuator 256 may be operated with a train of electrical tension pulses, which may define a rectangular pulse wave. This train of electrical tension pulses is characterized by a duty-cycle, namely the percentage of one wave period in which the tension pulse is active. In order to rotate the shaft 257 in one direction (e.g. clockwise), the tension pulses will have a positive value and coherently the duty-cycle will be described by a positive percentage value. In order to rotate the shaft 257 in the opposite direction (e.g. counter-clockwise), the tension pulses will have a negative value and coherently the duty-cycle will be described by a negative percentage value. In both cases, by varying the absolute value of the duty-cycle of the electrical tension pulses, it is possible to regulate the mean value of the electrical tension supplied to the VGT actuator 256, thereby regulating the speed and the torque of the rotating shaft 257. More particularly, the speed and the torque of the rotating shaft 257 increase as much as the absolute value of the duty-cycle of the electrical tension pulses increases.

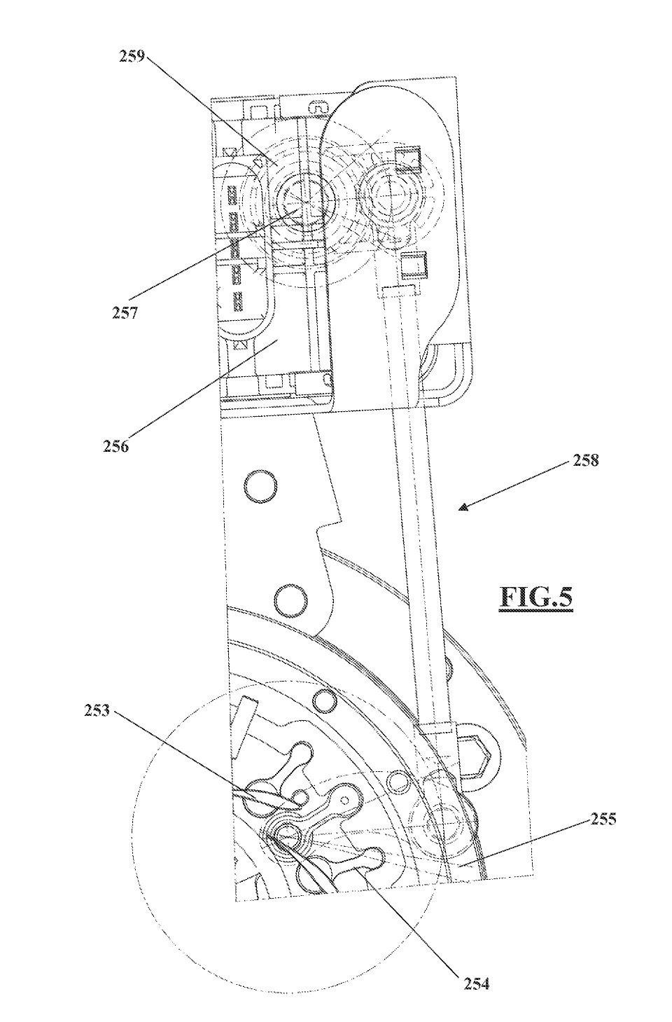

To monitor the position of the vanes 253, the turbocharger 230 may be provided with an angular position sensor 259, as shown in dotted line in FIG. 5, which is configured to generate an electric signal representative of the angular position of the rotating shaft 257, and consequently of the movable vanes 253. The position sensor 259 may be incorporated in the VGT actuator 256 and may include a lobed rotor, directly coupled to the shaft 257, and a stator configured to generate a voltage signal having an amplitude that depends on the position of the rotor lobes with respect to the stator. The voltage signal may be a digital signal, quantified in terms of bits.

The exhaust gases exit the turbine 250 and are directed into an exhaust system 270. The exhaust system 270 may include an exhaust pipe 275 having one or more exhaust aftertreatment devices 280. The aftertreatment devices may be any device configured to change the composition of the exhaust gases. Some examples of aftertreatment devices 280 include, but are not limited to, catalytic converters (two and three way), oxidation catalysts, lean NOx traps, hydrocarbon adsorbers, selective catalytic reduction (SCR) systems, and particulate filters. Other embodiments may include an exhaust gas recirculation (EGR) system 300 coupled between the exhaust manifold 225 and the intake manifold 200. The EGR system 300 may include an EGR cooler 310 to reduce the temperature of the exhaust gases in the EGR system 300. An EGR valve 320 regulates a flow of exhaust gases in the EGR system 300.

The automotive system 100 may further include an electronic control unit (ECU) 450 in communication with one or more sensors and/or devices associated with the ICE 110. The ECU 450 may receive input signals from various sensors configured to generate the signals in proportion to various physical parameters associated with the ICE 110. The sensors include, but are not limited to, a mass airflow and temperature sensor 340, a manifold pressure and temperature sensor 350, a combustion pressure sensor 360, coolant and oil temperature and level sensors 380, a fuel rail pressure sensor 400, a cam position sensor 410, a crank position sensor 420, exhaust pressure and temperature sensors 430, an EGR, temperature sensor 440, an accelerator pedal position sensor 445, and the position sensor 259 of the VGT actuator shaft 257. Furthermore, the ECU 450 may generate output signals to various control devices that are arranged to control the operation of the ICE 110, including, but not limited to, the fuel injectors 160, the throttle body 330, the EGR Valve 320, the cam phaser 155 and the VGT actuator 256. Note, dashed lines are used to indicate communication between the ECU 450 and the various sensors and devices, but some are omitted for clarity.

Turning now to the ECU 450, this apparatus may include a digital central processing unit (CPU) in communication with a memory system and an interface bus. The CPU is configured to execute instructions stored as a program in the memory system 460, and send and receive signals to/from the interface bus. The memory system 460 may include various storage types including optical storage, magnetic storage, solid state storage, and other non-volatile memory. The interface bus may be configured to send, receive, and modulate analog and/or digital signals to/from the various sensors and control devices. The program may embody the methods disclosed herein, allowing the CPU to carryout out the steps of such methods and control the ICE 110.

The program stored in the memory system 460 is transmitted from outside via a cable or in a wireless fashion. Outside the automotive system 100 it is normally visible as a computer program product, which is also called computer readable medium or machine readable medium in the art, and which should be understood to be a computer program code residing on a carrier, whether transitory or non-transitory in nature with the consequence that the computer program product can be regarded to be transitory or non-transitory in nature.

An example of a transitory computer program product is a signal, e.g. an electromagnetic signal such as an optical signal, which is a transitory carrier for the computer program code. Carrying such computer program code can be achieved by modulating the signal by a conventional modulation technique such as QPSK for digital data, such that binary data representing said computer program code is impressed on the transitory electromagnetic signal. Such signals are e.g. made use of when transmitting computer program code in a wireless fashion via a WiFi connection to a laptop.

In case of a non-transitory computer program product the computer program code is embodied in a tangible storage medium. The storage medium is then the non-transitory carrier mentioned above, such that the computer program code is permanently or non-permanently stored in a retrievable way in or on this storage medium. The storage medium can be of conventional type known in computer technology such as a flash memory, an Asic, a CD or the like.

Instead of an ECU 450, the automotive system 100 may have a different type of processor to provide the electronic logic, e.g. an embedded controller, an on-board computer, or any processing module that might be deployed in the vehicle.

ECU 450 is operable for adjusting, during the normal operation of the engine 110, the orientation of the movable vanes 253 of the VGT 250 on the basis of a predetermined boost request. By varying the angular orientation of the vanes 253, the ECU 450 changes the gas swirl angle and the cross sectional area of the turbine inlet, thereby altering the flow of the exhaust gases through the VGT 250. The boost request may be determined by the ECU 450 on the basis of several engine operating parameters and/or conditions, including for example the engine speed. Once the boost request has been determined, the ECU 450 is configured to operate the VGT actuator 256 so as to place the movable vane 235 in a position that corresponds to that predetermined boost request.

Potentially, the vanes 253 can rotate between two mechanical-end-stop positions, namely a fully-open position (shown in FIGS. 3 and 4) and a fully-close position (not shown). In the fully-open position, which may be determined by a mechanical pin 260 (see FIG. 3), or by another similar stationary mechanical stop, the vanes 253 are at their maximum inclination towards the central axis A of the turbine wheel 252, thereby maximizing the cross sectional area and thus the mass flow rate of the incoming exhaust gases. In the fully-close position, which is generally determined by a mutual contact between the vanes 253, the vanes 253 are almost tangentially oriented with respect to the central axis A of the turbine wheel 252, thereby minimizing the cross sectional area and the exhaust gas mass flow rate. In other embodiments, also the fully-close position may be determined by a mechanical pin, instead of the mutual contact between the vanes 253.

However, during the normal operation of the engine 110, the ECU 450 is configured so that these fully-open and the fully-closed positions are never reached. Instead, the vanes 253 are bound to rotate between a minimum flow (Min-Flow) position that is proximal to (but still separated from) the frilly-closed position and a maximum flow (Max-Flow) position that is proximal to (but still separated from) the fully-open position.

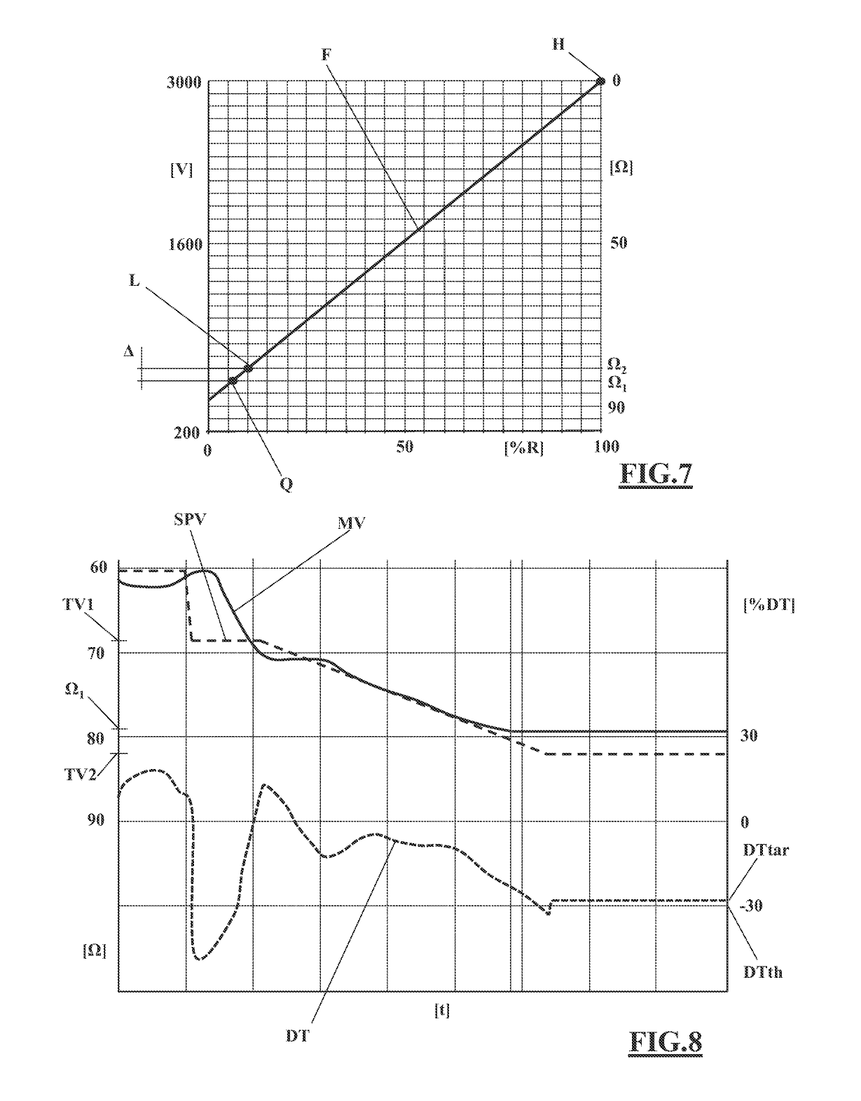

Referring to the diagram of FIG. 7, the Min-Flow position is indicated by the point H. The Min-Flow position H is the position of the VGT vanes that corresponds to a maximum (100%) of the boost request. This position is generally determined for each VGT 250 individually, by means of a test which is performed by the VGT supplier at the end of the production line. During this test, the position sensor 259 is also calibrated so that the Min-Flow position H of the vanes 253 corresponds to a predetermined value of the electrical signal generated by the sensor 259, for example 3000 bit. Starting from this Min-Flow position H, the vanes 253 are allowed to rotate towards more open positions that correspond to lower values of the boost request and lower values of the electric signal generated by the position sensor 259, for example according to the characteristic curve F drawn in FIG. 7. This characteristic curve F, which may be memorized in the memory system 460 in the form of a mathematical model, a map, a computer code or the like, may be provided by the supplier of the VGT 250 and is the same for all the VGTs of the same family.

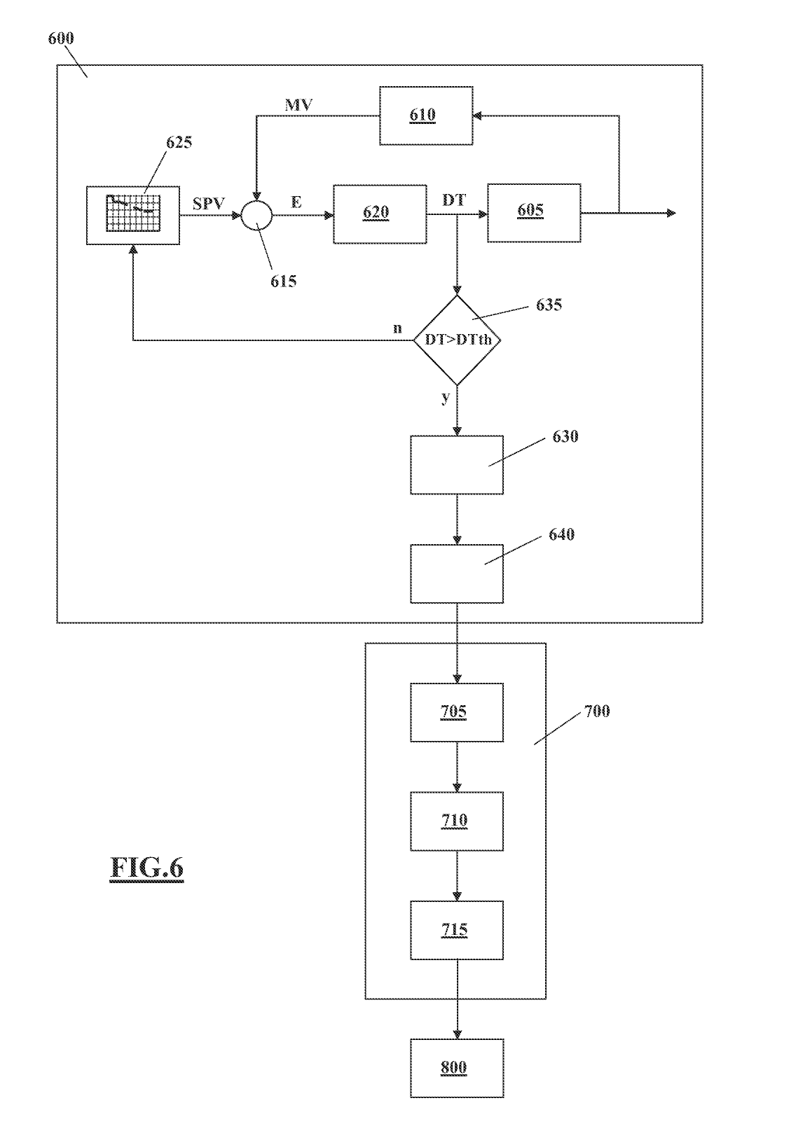

In order to determine the Max-Flow position L that can be reached by the vanes 253 during the normal operation of the engine 110, the ECU 450 of the automotive system 100 may be configured to perform a testing procedure, as represented in the flowchart of FIG. 6. This testing procedure may be performed only once or it may be periodically repeated during the lifetime of the automotive system 100, for example when the engine 110 is going to be started or after engine switched off.

In general terms, the testing procedure provides for the ECU 450 to operate the VGT actuator 256 to rotate the movable vanes 253 towards the fully-open position (block 600), until they actually reach the mechanical pin 260, as indicated by the point Q in the characteristic curve of FIG. 7. Once the vanes 253 stop against the mechanical pin 260, the testing procedure provides for the ECU 450 to use the position sensor 259 to learn the value Ω₁ corresponding to the position Q actually reached by the vanes 253 (block 700). The ECU 450 may then be configured to use the learned position value Ω₁ to calculate a threshold position value Ω₂ that will define and correspond to the max-flow position L (block 800).

By way of example, the max-flow position value Ω₂ may be calculated with the following equation:

Ω²=Ω₁−Δ

Wherein:
Ω₁ is the learned position value expressed as an angular distance from the Min-Flow position H; and
Δ is a predetermined angular offset.
   This angular offset may be a calibration parameter which may be determined with an experimental activity and then memorized in the memory system 460. In particular, the angular offset Δ is determined to be large enough to prevent that, during the normal operations of the engine 110, the vanes 253 can touch the mechanical pin 260, even in case of small control errors of the VGT actuator 256. By way of example, the angular offset Δ may be of about 2.5° (angular degrees).

The calculated max-flow position value Ω₂ is finally set as the angular limit beyond which the movable vanes 253 will not be allowed to rotate during the normal operation of the engine 1110. In some embodiments, the calculated max-flow position value Ω₂ may be converted with the characteristic curve of FIG. 7 in a corresponding minimum allowable value of the boost request. As a result, the characteristic curve F (which is the same for all the VGTs 250 of the same family) is actually limited (cut) to a specific max-flow position L (corresponding to Ω₂) that is determined for each VGT 250 individually.

Going back to the testing procedure, the movable vanes 253 may be rotated towards the fully-open position using a closed-loop control strategy, which is schematically shown in FIG. 6. This closed-loop control strategy provides for the ECU to apply to the VGT actuator 256 a train of electrical tension pulses (block 605), to cyclically measure the position of the VGT vanes 253 with the position sensor 259 (block 610), to calculate an error E (i.e. a difference) between the measured value MV of the vane's position and a predetermined set-point value SPV thereof (block 615), and then to use the error E as input of a controller 620, for example a proportional-integral-derivative or PID controller, which is configured to adjust the duty-cycle DT of the electrical tension pulses in such a way to minimize the calculated error E. The set-point value SPV and the measured value MV of the vane's position may be both expressed in terms of an angular distance from the Min-Flow position of the movable vanes 253.

While performing this closed loop control strategy, the ECU 450 may be configured to vary the set-point value SPV of the vane's position as represented by the block 625 of FIG. 6 and described in details by the diagram of FIG. 8. In particular, the ECU 450 initially sets the set-point value SPY at a predetermined first target value TV1, which represents a vane's position that certainly precedes the fully-open position Ω₄ defined by the mechanical pin 260 (with respect to the rotation direction of the vanes towards the fully-open position). According to this example, the first target value TV1 is chosen to be smaller than the value Ω₁ representative of the fully-open position. More particularly, since the exact value Ω₁ is still unknown, the first target value TV1 may be chosen to be smaller than a range of position values that, on statistical basis, will certainly contain the fully open position Ω₁. The first target value TV1 may be a calibration value determined with an experimental activity and memorized in the memory system 460.

While keeping the set-point value SPV steady at this first target value TV1, the duty-cycle DT of the electrical tension pulses changes in response to the closed-loop control strategy, thereby operating the VGT actuator 256 to rotate the vanes 253 towards the position corresponding to the value TV1.

Once the vanes 253 have reached the position corresponding to the first target value TV1, the ECU 450 is configured to progressively vary the set-point value SPV from the first target value TV1 to a second target value TV2. The second target value TV2 represents a vane's position that is certainly beyond the fully-open position Ω₁ defined by the mechanical pin 260 (with respect of the rotation direction of the vanes towards the fully-open position). According to this example, the second target value TV2 is chosen to be larger than the value Ω₁ representative of the fully-open position. More particularly, since the exact value Ω₁ is still unknown, the second target value TV2 may be chosen to be larger than a range of position values that, on statistical basis, will certainly contain the fully open position. The second target value TV2 may be a calibration value determined with an experimental activity and memorized in the memory system 460.

While the set-point value SPY varies from the first target value TV1 to the second target value TV2, the closed-loop control strategy automatically adjusts the duty-cycle DT of the electrical tension pulses (see FIG. 8), thereby progressively operating the VGT actuator 256 to rotate the vanes 253 towards the position corresponding to the target value TV2. Since the target value TV2 represents a vane's position beyond the fully-open position, the vanes 253 will never reach said target value TV2 but are destined to stop earlier against the mechanical pin 260.

The variation of the set-point value SPV from the first target value TV1 to the second target value TV2 may be linear over the time. In particular, the variation rate (i.e. the slope of the ramp that connects TV1 and TV2) may be chosen so that the vanes 253 approach the mechanical pin 260 slowly enough to prevent heavy impacts. The variation rate may be a calibration parameter determined with an experimental activity and memorized in the memory system 460.

When the vanes 253 have reached the mechanical pin 260, the absolute value of the duty-cycle DT of the electrical tension pulses signal will start to abruptly increase (note that the duty-cycle values are negative in the diagram of FIG. 8), because the controller 620 becomes unable to compensate the increasing error E between the set-point value SPY and the measured position value MV.

Taking advantage of this phenomenon, the ECU 450 may be configured to monitor the absolute value of the duty-cycle DT of the electrical tension pulses and to identify (block 630 of FIG. 6) that the movable vanes 253 have reached the mechanical pin 260, when the duty-cycle absolute value of the electrical tension pulses exceeds a predetermined threshold value DTth thereof (block 635).

In order to not be misled by possible spikes in the duty-cycle absolute value, due for example to noises or other transitory phenomena, the identification may be made when the duty-cycle absolute value of the electrical tension pulses exceeds the threshold value DTₜₕ for more than a predetermined time delay. The threshold value DTₜₕ of the duty-cycle and the time delay may be calibration parameters determined with an experimental activity and memorized in the memory system 460. By way of example, the threshold value DTth of the duty-cycle may be of about 30%.

Once the vanes 253 have been identified to be in the fully-open position, the ECU 450 may be configured to stop the closed-loop control strategy but to continue to operate the VGT actuator 256 to push the vanes 253 against the mechanical pin 260 (block 635). To do so, the ECU 450 may be configured to apply to the VGT actuator 256 a train of electrical tension pulses having a predetermined target value (i.e. absolute value) DTₜₐᵣ of the duty-cycle. The target value DTₜₐᵣ is different from 0 (zero) but smaller than the threshold value DTₜₕ, so that the movable vanes 253 are kept firmly against the mechanical stop 260 but without overheating the VGT actuator.

The target value DTₜₐᵣ may be a calibration parameter determined with an experimental activity and memorized in the memory system 460. By way of example, the target value DTₜₐᵣ of the duty-cycle may be of about 28%.

While the movable vanes 253 are in this condition, the ECU 450 performs the above-mentioned learning of the fully-open position (Block 700 of FIG. 6). In particular, the ECU 450 may be configured to measure several times the position of the movable vanes 253 with the position sensor 259 (block 705), to calculate an average of the measured values of the vanes' position (block 710), and finally to set the calculated average as the position value Ω₁ that corresponds to the fully-open position of the movable vanes 253 (block 715). In the end, the ECU 450 may use the learned position value Ω₁ to calculate the max-flow position value as explained above (block 800).

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-13. (canceled)

14. A turbocharger system for an internal combustion engine comprising:
a turbine assembly having movable vanes;
an electric actuator operable coupled to the turbine assembly for rotating the movable vanes;
a position sensor operable to learn a position value (Ω₁) of the movable vanes; and
an electronic control unit operably coupled the electric actuator and configured to:
operate the electric actuator to rotate the movable vanes to a fully-open position in which the vanes reach a mechanical stop;
learn a position value of the movable vanes once they have reached the mechanical stop.

15. A turbocharger system according to claim 14, wherein the electronic control unit is further configured to calculate a threshold position value (Ω₂) corresponding to a max-flow position based on the learned position value, wherein the movable vanes are not allowed to rotate beyond the max-flow position during the normal operations of the turbocharger system.

16. A turbocharger system according to claim 15, wherein the electronic control unit is further configured to limit a predetermined characteristic curve (F) based on the threshold value, wherein the predetermined characteristic curve correlates the values of an electrical signal generated by the position sensor to correspondent values of the vanes position.

17. A turbocharger system according to claim 15, wherein the electronic control unit is further configured to calculate the threshold position value (Ω₂) as the difference between the learned position value (Ω₁) and a predetermined angular offset (Δ).

18. A turbocharger system according to claim 14, wherein the electronic control unit is further configured to:
supply the electric actuator with a train of electrical tension pulses to rotate the movable vanes towards the mechanical stop;
receive a signal from the position sensor indicative of the position of the movable vanes during the rotation;
calculate an error (E) between a measured value (MV) of the movable vanes position and a set-point value (SPV) thereof; and
adjust a duty-cycle value (DT) of the electrical tension pulses based on the calculated error (E).

19. A turbocharger system according to claim 18, wherein the electronic control unit is further configured to vary the set-point value (SPV) of the position of the vane from a first target value (TV₁) to a second target value (TV₂), wherein the first target value represents a first position of the vane that precedes the fully-open position and the second target value represents a second position of the vane that is beyond the fully-open position.

20. A turbocharger system according to claim 19, wherein the electronic control unit is further configured to vary the set-point value (SPV) from the first to the second target value linearly over the time.

21. A turbocharger system according to claim from 18, wherein the electronic control unit is further configured to identify when the movable vanes have reached the mechanical stop based on an absolute value of the duty-cycle (DT) of the electrical tension pulses.

22. A turbocharger system according to claim 21, wherein the electronic control unit is configured to identify that the movable vanes have reached the mechanical stop when the duty-cycle absolute value of the electrical tension pulses exceeds a predetermined threshold value (DTₜₕ) thereof.

23. A turbocharger system according to claim 22, wherein the electronic control unit is configured to supply the electric actuator with a train of electrical tension pulses having a predetermined target value (DTₜₐᵣ) of the duty-cycle, wherein the duty-cycle target value (DTₜₐᵣ) is smaller than the threshold value (DTth) thereof once the movable vane have reached the mechanical stop.

24. A turbocharger system according to claim 18, wherein the controller comprises a proportional-integrative-derivative controller.

25. A turbocharger according to claim 14, wherein the electronic control unit is further configured to:
measure the position of the movable vanes several times using the position sensor;
calculate an average of the measured position values; and
set the calculated average as the position value (Ω₁) of the movable vanes corresponding to the fully-open position.

26. An automotive system comprising an internal combustion engine and a turbocharger system according to claim 14.
